(19) United States
(12) Patent Application Publication
(10) Pub. No.: US 2025/0104308 A1
(43) Pub. Date: Mar. 27, 2025

(54) METHOD AND APPARATUS FOR GENERATING STYLIZED IMAGE, ELECTRONIC DEVICE, AND STORAGE MEDIUM

(71) Applicant: Beijing Zitiao Network Technology Co., Ltd., Haidian District, Beijing (CN)

(72) Inventors: Caijin ZHOU, Beijing (CN); Wenyue Li, Beijing (CN)

(21) Appl. No.: 18/730,701

(22) PCT Filed: Jan. 13, 2023
(86) PCT No.: PCT/CN2023/072067

§ 371 Date: Jul. 19, 2024

(30) Foreign Application Priority Data
Jan. 20, 2022 (CN) 202210067042.1

(51) Int. Cl. G06T 11/60

(52) U.S. Cl. CPC G06T 11/60

(57) ABSTRACT

Embodiments of the present disclosure provide a method and apparatus for generating a stylized image, an electronic device and a storage medium. The method includes: acquiring model parameters to be transferred of a face image generation model to construct a first sample generation model to be trained and a second sample generation model to be trained; respectively training corresponding sample generation models to be trained based on training samples of a first style type and a training sample of a second style type to obtain a first target sample generation model and a second target sample generation model; and determining a target style data generation model based on model parameters to be fitted of the two target sample generation models to generate, based on the target style data generation model, a stylized image in which the two style types are fused.

The present disclosure claims the priority to Chinese Application No. 202210067042.1, filed in the China Patent Office on Jan. 20, 2022, and the disclosure of which is incorporated herein by reference in its entity.

### FIELD

Embodiments of the present disclosure relate to the technical field of data processing, for example, to a method and apparatus for generating a stylized image, an electronic device and a storage medium.

### BACKGROUND

With the continuous development of image processing technologies, a user may process an image by using a plurality of applications, so that the processed image presents a desired style type of the user.

In related arts, before providing corresponding services for the user, related algorithms for image processing often need to train models by using a large amount of data, however, this manner needs to consume a large amount of cost, and meanwhile, when a related image of a certain style type cannot be acquired, an effective algorithm model cannot be constructed for this style type.

### SUMMARY

Embodiments of the present disclosure provide a method and apparatus for generating a stylized image, an electronic device and a storage medium, which may efficiently construct a target style data generation model without using a large number of training samples in which two style types are fused, thereby reducing the cost consumed in a model construction process.

In a first aspect, an embodiment of the present disclosure provides a method for generating a stylized image, including:
acquiring model parameters to be transferred of a face image generation model, so as to construct a first sample generation model to be trained and a second sample generation model to be trained based on the model parameters to be transferred;
training the first sample generation model to be trained based on training samples of a first style type, so as to obtain a first target sample generation model;
training the second sample generation model to be trained based on training samples of a second style type, so as to obtain a second target sample generation model; and
determining a target style data generation model based on model parameters to be fitted of the first target sample generation model and model parameters to be fitted of the second target sample generation model, so as to generate, based on the target style data generation model, a stylized image in which the first style type is fused with the second style type.

In a second aspect, an embodiment of the present disclosure further provides an apparatus for generating a stylized image, including:
a model parameter to be transferred-acquiring module, configured to acquire model parameters to be transferred of a face image generation model, so as to construct a first sample generation model to be trained and a second sample generation model to be trained based on the model parameters to be transferred;
a first sample generation model to be trained-training module, configured to train the first sample generation model to be trained based on training samples of a first style type, so as to obtain a first target sample generation model;
a second sample generation model to be trained-training module, configured to train the second sample generation model to be trained based on training samples of a second style type, so as to obtain a second target sample generation model; and
a target style data generation model-determining module, configured to determine a target style data generation model based on model parameters to be fitted of the first target sample generation model and model parameters to be fitted of the second target sample generation model, so as to generate, based on the target style data generation model, a stylized image in which the first style type is fused with the second style type.

In a third aspect, an embodiment of the present disclosure further provides an electronic device, including:
at least one processor; and
a storage unit, configured to store at least one program, wherein,
when the at least one program is executed by the at least one processor, the at least one processor implements the method for generating the stylized image provided in any embodiment of the present disclosure.

In a fourth aspect, an embodiment of the present disclosure further provides a storage medium, including a computer-executable instruction, wherein the computer-executable instruction is used for, when being executed by a computer processor, implementing the method for generating the stylized image provided in any embodiment of the present disclosure.

### BRIEF DESCRIPTION OF THE DRAWINGS

Throughout the drawings, the same or similar reference signs represent the same or similar elements. It should be understood that the drawings are schematic, and components and elements are not necessarily drawn to scale.

FIG. 1 is a schematic flowchart of a method for generating a stylized image provided in Embodiment 1 of the present disclosure;

FIG. 2 is a schematic diagram of constructing a first sample generation model to be trained and a second sample generation model to be trained based on a face image generation model provided in Embodiment 1 of the present disclosure;

FIG. 3 is a schematic diagram of constructing a target style data generation model based on a first target sample generation model and a second target sample generation model provided in Embodiment 1 of the present disclosure;

FIG. 4 is a schematic flowchart of a method for generating a stylized image provided in Embodiment 2 of the present disclosure;

FIG. 5 is a schematic flowchart of an apparatus for generating a stylized image provided in Embodiment 3 of the present disclosure; and

FIG. 6 is a schematic structural diagram of an electronic device provided in Embodiment 4 of the present disclosure.

### DETAILED DESCRIPTION OF EMBODIMENTS

It should be understood that, various steps recorded in method embodiments of the present disclosure may be executed in different sequences and/or in parallel. In addition, the method embodiments may include additional steps and/or omit executing the steps shown. The scope of the present disclosure is not limited in the this aspect.

As used herein, the terms “include” and variations thereof are open-ended terms, i.e., “including, but not limited to”. The term “based on” is “based, at least in part, on”. The term “one embodiment” means “at least one embodiment”; the term “another embodiment” means “at least one additional embodiment”; and the term “some embodiments” means “at least some embodiments”. Relevant definitions of other terms will be given in the following description.

It should be noted that, concepts such as “first” and “second” mentioned in the present disclosure are only intended to distinguish different apparatuses, modules or units, and are not intended to limit the sequence or interdependence of the functions executed by these apparatuses, modules or units.

It should be noted that, the modifiers of “one” and “more” mentioned in the present disclosure are illustrative, and those skilled in the art should understand that the modifiers should be interpreted as “at least one” unless the context clearly indicates otherwise.

### Embodiment 1

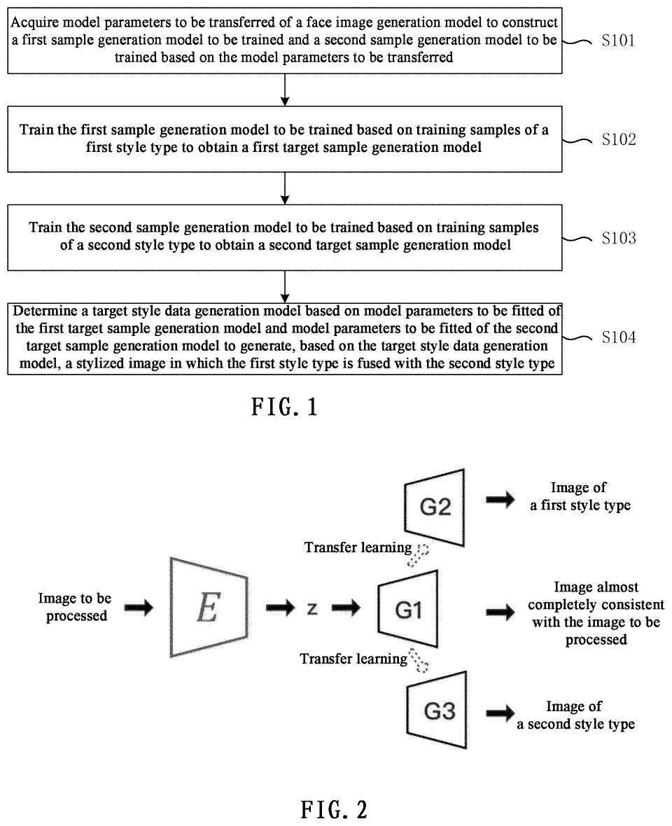

FIG. 1 is a schematic flowchart of a method for generating a stylized image provided in Embodiment 1 of the present disclosure, the present embodiment may be applicable to a scenario in which a specific style data generation model is constructed, the constructed model is configured to generate a stylized image in which two style types are fused, the method may be executed by an apparatus for generating a stylized image, the apparatus may be implemented in a form of software and/or hardware, and the hardware may be an electronic device, such as a mobile terminal, a personal computer (PC) terminal, a server, or the like. Any image display scenario is usually implemented by the cooperation of a client and a server, and the method provided in the present embodiment may be executed by the server, by the client, or by the cooperation of the client and the server.

As shown in FIG. 1, the method in the present embodiment includes:
S101, acquiring model parameters to be transferred of a face image generation model, so as to construct a first sample generation model to be trained and a second sample generation model to be trained based on the model parameters to be transferred.

In the present embodiment, the face image generation model may be a neural network model used for generating a face image of a user. It can be understood that, after related facial features of the user are input into the face image generation model, a face image consistent with the facial features of the user may be obtained after model processing.

In an actual application process, the face image generation model may be a stylegan model based on a generative adversarial network (GAN), wherein the generative adversarial network is composed of a generative network and a discriminative network. The generative network randomly samples from a potential space as an input, and an output result thereof needs to simulate a real sample in a training set as much as possible, and the input of the discriminative network is the real sample and an output of the generative network. Based on this, it can be understood that the stylegan model in the present embodiment may also include a generator and a discriminator, and Gaussian noise corresponding to the face image of the user may be processed by using the generator, so as to regenerate a face image of the user; and related parameters in the generator may be adjusted by using the discriminator. The advantages of using the discriminator including the discriminative network lie in that, the face image of the user, which is regenerated by the stylegan model with parameters corrected, may be almost completely consistent with the face image of the user corresponding to the input Gaussian noise. It should be noted that, in the field of high-definition image generation, the stylegan model has very excellent expression capability, and may at least generate high-definition pictures with resolutions of up to 1024*1024.

The schematic diagram of constructing the first sample generation model to be trained and the second sample generation model to be trained based on the face image generation model in FIG. 2 is taken as an example, wherein G1 represents the face image generation model, and a clear facial schematic diagram may be obtained after Gaussian noise is input. In the present embodiment, in order that the output of the face image generation model is almost completely consistent with a face image corresponding to an input Gaussian vector, training is still required to obtain the face image generation model. Optionally, the face image generation model is obtained in the following manner: acquiring a plurality of basic training samples; processing Gaussian noise based on an image to be trained generator, so as to generate an image to be discriminated; performing discrimination processing on the image to be discriminated and a collected real face image based on a discriminator, so as to determine a reference loss value; correcting model parameters in the image to be trained generator based on the reference loss value; and converging a loss function in the image to be trained generator as a training target, so as to obtain the face image generation model.

The basic training samples are data used for training the face image generation model, each basic training sample is Gaussian noise corresponding to the facial information of a target subject, wherein the facial information of the target subject is an image including the facial information of the user, for example, an ID photo or a life photo of the user, and the Gaussian noise may be understood as a high-dimensional vector corresponding to the facial information of the target subject. It should be noted that, in the actual application process, a large number of basic training samples may be acquired based on a large public data set FFHQ (the data set is a facial feature data set).

Meanwhile, it can also be determined according to the above description that, when the face image to be trained generation model is a stylegan model, the model is composed of an image to be trained generator and a discriminator. Therefore, after the plurality of basic training samples are acquired, a large amount of Gaussian noise may be processed by using the image to be trained generator, so as to generate an image to be discriminated, that is, an image which may has a difference from a real face image input by the user. After the image to be discriminated is determined, the reference loss value between the image to be discriminated and the real face image may be determined based on the discriminator. When the model parameters in the image to be trained generator are corrected by using the reference loss value, a training error of the loss function in the image to be trained generator, that is, a loss parameter, may be used as a condition for detecting whether the loss function reaches convergence, for example, whether the training error is less than a preset error or whether an error change trend tends to be stable, or whether the current number of iterations is equal to a preset number of iterations. If it is detected that a convergence condition is met, for example, the training error of the loss function is less than the preset error, or the error change trend tends to be stable, it indicates that the training of the face image to be trained generation model is completed, and at this time, iterative training may be stopped. If it is detected that the convergence condition is not met at present, other basic training samples may be further acquired to continue to train the model, until the training error of the loss function is within a preset range. It can be understood that, when the training error of the loss function reaches convergence, a trained face image generation model may be obtained, at this time, after the Gaussian vector corresponding to the face image of the user is input into the model, an image almost completely consistent with the face image of the user may be obtained, and taking FIG. 2 as an example, an image output by the trained G1 is almost completely consistent with the image corresponding to the input Gaussian noise. Generally, it is relatively difficult to train the face image generation model by using a large amount of data, it is necessary to consume more computing resources, meanwhile, if a model for generating a specific style type image is desired to be obtained by training, a large number of images belonging to the style type need to be acquired as training samples, and samples of a certain style type are almost absent or difficult to be acquired, correspondingly, the model of this style type cannot be obtained by training in actual applications, and thus a photographed image cannot be converted into an image of this style. Therefore, in the present embodiment, after the parameters of the face image generation model are trained, the model for generating the specific style type image may be obtained by using transfer learning. In the field of artificial intelligence, transfer learning is to apply knowledge or modes learned from a certain field or task to different but related fields or problems, that is, to transfer annotation data or knowledge structures from related fields, and to complete or improve the learning effects of target fields or tasks. In the present embodiment, the advantage of using transfer learning lies in that, under the condition of a small number of samples, a model for generating a certain style type may be obtained by training.

Exemplarily, in order to obtain the model for generating the specific style type image, trained parameters in the face image generation model may be used as model parameters to be transferred, and the first sample generation model to be trained and the second sample generation model to be trained are constructed based on the parameters.

It can be understood that, the advantages of constructing the first sample generation model to be trained and the second sample generation model to be trained through transfer learning lie in that, the model for generating the specific style type image may be efficiently constructed by using the trained model parameters, thereby not only avoiding the tedious process of acquiring a large number of model pictures of the style as training data, that is, eliminating the problem of sample acquisition difficulty, and meanwhile, reducing the consumption of computing resources.

Still taking FIG. 2 as an example for illustration, after it is determined that the face image generation model is G1, the model parameters to be transferred of G1 may be acquired, a first sample generation model to be trained G2 and a second sample generation model to be trained G3 are generated based on transfer learning; as can be seen from FIG. 2, after the Gaussian noise corresponding to the face image of the user is input into G2 for processing, an image output by the model presents a specific regional dressing style while retaining the unique facial features of the user, for example, an image of a first style type output by G2 may be an image added with local regional clothing, hairstyles, hair accessories and makeups based on the original facial features of the user; after the Gaussian noise corresponding to the face image of the user is input into G3 for processing, an image output by the model presents an ancient style while retaining the unique facial features of the user, for example, an image of a second style type output by G3 may be an image added with character features in ancient style paintings based on the original facial features of the user, and it can be understood that the true-life face image of the user presents a visual effect of ancient character paintings.
S102, training the first sample generation model to be trained based on training samples of a first style type, so as to obtain a first target sample generation model.

In the present embodiment, after the first sample generation model to be trained is obtained, the training samples of the first style type may be acquired to train the model. The first style type is a regional style image, for example, a face image of the user with a certain unique dressing style, and this dressing style corresponds to a certain region, therefore it can be understood that the first style type is a style type that presents features such as clothing, hairstyles, hair accessories and makeups of users in the certain region. Each training sample includes a first face image of the first style type. The first face image may be processed based on a trained target compilation model, so as to generate Gaussian noise corresponding to the first face image. Taking FIG. 2 as an example, when the first sample generation model to be trained is a model for generating a specific regional style image, the corresponding training samples are a plurality of images of the dressing styles of the users in the region, and these images are the first face images.

The process of training the first sample generation model to be trained includes: acquiring a plurality of training samples of the first style type; inputting Gaussian noise corresponding to the first face images into the first sample generation model to be trained, so as to obtain first actual output images; performing discrimination processing on the first actual output images and the corresponding first face images based on the discriminator, so as to determine loss values, and then correcting model parameters in the first sample generation model to be trained based on the loss values; and converging a loss function in the first image to be trained generation model as a training target, so as to obtain the first target sample generation model.

Exemplarily, after the plurality of training samples of the first style type are acquired, a plurality of pieces of Gaussian noise may also be processed by using an image generator in the first sample generation model to be trained, so as to generate first actual output images to be discriminated, that is, images having differences from the first face images. After the first actual output images and the corresponding first face images are determined, a plurality of corresponding loss values may be determined based on the discriminator. When the model parameters in the first sample generation model to be trained are corrected by using the plurality of loss values, a training error of the loss function in the model, that is, a loss parameter, may be used as a condition for detecting whether the loss function reaches convergence, for example, whether the training error is less than a preset error or whether an error change trend tends to be stable, or whether the current number of iterations is equal to a preset number of iterations. If it is detected that a convergence condition is met, for example, the training error of the loss function is less than the preset error, or the error change trend tends to be stable, it indicates that the training of the first sample generation model to be trained is completed, and at this time, iterative training may be stopped. If it is detected that the convergence condition is not met at present, other training samples of the first style type may be further acquired to continue to train the model, until the training error of the loss function is within a preset range. It can be understood that, when the training error of the loss function reaches convergence, a trained first target sample generation model may be obtained, at this time, after the Gaussian noise corresponding to the face image of the user is input into the model, it is possible to obtain a face image of the user, which not only retains the unique facial features of the user, but also presents the first style type.

It should be noted that, since the first sample generation model to be trained is constructed based on the trained face image generation model, only a small number of training samples of the first style type need to be used to train the model, so as to obtain the first target sample generation model, and in the actual application process, the training samples may be about 200 images of the first style type (i.e, the first face images), meanwhile, these images should have similar structures with the face images input by the user, for example, all the images have features of the user, such as five sense organs and hair.

In this way, not only the convenience of model training is improved, meanwhile, the corresponding target sample generation model may be trained when the images of the specific style type are few, thereby greatly reducing the requirements of the model to be trained for the training samples.
S103, training the second sample generation model to be trained based on training samples of a second style type, so as to obtain a second target sample generation model.

In the present embodiment, after the second sample generation model to be trained is obtained, the training samples of the second style type may be acquired to train the model. The second style type is an ancient style image, for example, an image of an ancient character painting style, and it can be understood that the second style type is a style type that presents features such as ancient claborate-style paintings and oil paintings. Each training sample includes a second face image of the second style type, after the second face images are processed, Gaussian noise for reflecting corresponding facial features may also be obtained, taking FIG. 2 as an example, when the second sample generation model to be trained is a model for generating an ancient style image, the corresponding training samples are a plurality of images of an ancient style, and these images are the second face images.

The process of training the second sample generation model to be trained includes: acquiring a plurality of training samples of the second style type; inputting Gaussian noise corresponding to the second face images into the second sample generation model to be trained, so as to obtain second actual output images; performing discrimination processing on the second actual output images and the corresponding second face images based on the discriminator, so as to determine loss values, and then correcting model parameters in the second sample generation model to be trained based on the loss values; and converging a loss function in the second image to be trained generation model as a training target, so as to obtain the second target sample generation model.

Those skilled in the art should understand that, the process of training the second sample generation model to be trained based on the plurality of training samples of the second style type is similar to the process of training the first sample generation model to be trained based on the plurality of training samples of the first style type, and thus details are not described herein again in the embodiment of the present disclosure. Meanwhile, in the actual application process, only a small amount of training data of the second style type, for example, about 200 images of the second style type (i.e., the second face images), are required to train the second sample generation model to be trained to obtain the second target sample generation model, meanwhile, these images also have similar structures with the face images input by the user, for example, all the images need to have features of the user, such as five sense organs and hair. It can be understood that, the model training manner similar to that of the first sample generation model to be trained is also convenient, the requirements for the images of the second style type are reduced, and details are not described herein again in the embodiment of the present disclosure.
S104, determining a target style data generation model based on model parameters to be fitted of the first target sample generation model and model parameters to be fitted of the second target sample generation model, so as to generate, based on the target style data generation model, a stylized image in which the first style type is fused with the second style type.

In the present embodiment, after the first target sample generation model and the second target sample generation model are obtained by training, parameters of the two models can be acquired, and the target style data generation model is obtained based on model fusion, wherein model fusion is a process of training a plurality of models, and then integrating these models according to a certain method. After the face images input by the user are processed by the target style data generation model obtained by integration, the output images can not only retain the unique facial features of the user, but also present the first style type and the second style type at the same time, and these images, which present a plurality of style types, are stylized images.

Exemplarily, the target style data generation model is constructed in the following manner: firstly, acquiring a preset fitting parameter; performing fitting processing on model parameters to be fitted in the first target sample generation model and model parameters to be fitted in the second target sample generation model based on the fitting parameter, so as to obtain target model parameters; and determining the target style data generation model based on the target model parameters, wherein the fitting parameter may be a coefficient for representing a fusion degree of the two style types, and in an output stylized image, the fitting parameter is at least used for adjusting the weights of different style types, and it can be understood that the fitting parameter is used for controlling the style type presented by the output stylized image to more tend to which one of the two style types. In the actual application process, a developer may edit or modify the fitting parameter based on a corresponding control or program in advance, and details are not described herein again in the embodiment of the present disclosure.

Exemplarily, a linear combination may be performed on the model parameters of the first target sample generation model and the model parameters of the second target sample generation model based on the preset fitting parameter, so as to obtain the target model parameters, that is, parameters required for constructing the target style data generation model. Therefore, the target style data generation model can be obtained based on these parameters.

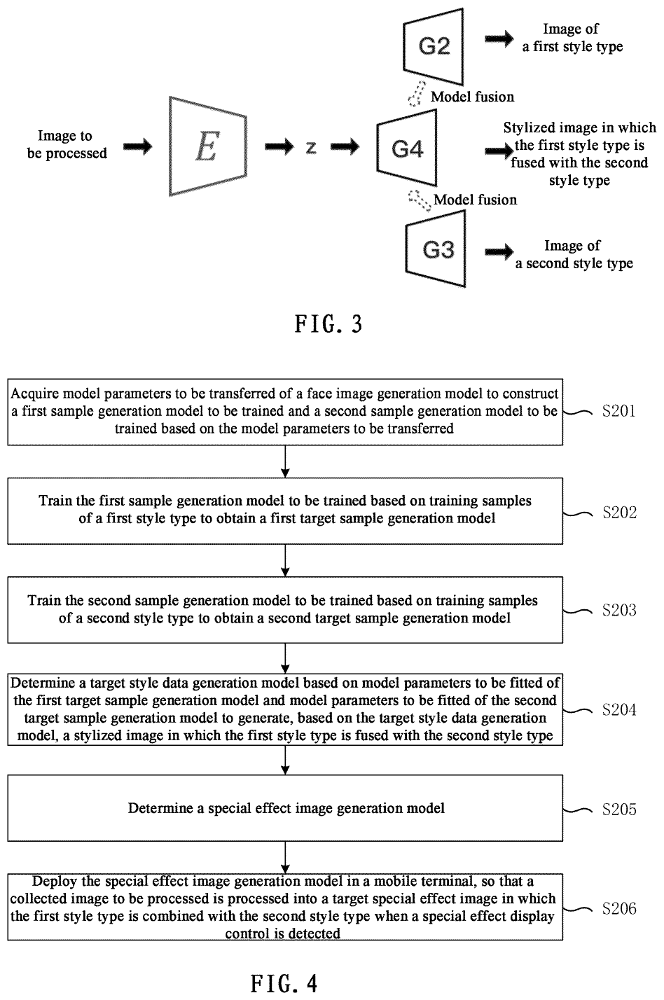

The schematic diagram of constructing the target style data generation model based on the first target sample generation model and the second target sample generation model in FIG. 3 is taken as an example, after the linear combination is performed on the model parameters of G2 and the model parameters of G3 based on the preset fitting parameter, a target style data generation model G4 may be constructed. As can be seen from FIG. 3, since G2 may obtain the images of the specific regional style based on the input of the user, and G3 may obtain the images of the ancient style based on the input of the user, after the constructed G4 processes the input of the user, an obtained image not only retains the unique facial features of the user, but also presents the specific regional style and the ancient style at the same time, for example, when the image of the first style type is an image added with local regional clothing, hairstyles, hair accessories and makeups, and the image of the first style type is an image added with character features in ancient style paintings, the stylized image, which is output by G4 and in which the first style type is fused with the second style type, may not only present local regional clothing, hairstyles, hair accessories and makeups while presenting the original facial features of the user, but also present the visual effect of ancient character paintings.

In the technical solution of the present embodiment, the model parameters to be transferred of the face image generation model are acquired at first, so as to construct the first sample generation model to be trained and the second sample generation model to be trained based on these parameters, the corresponding sample generation models to be trained are trained based on training samples of two style types, after the model training is completed, the model parameters to be fitted of the two target sample generation models are acquired, so as to determine the target style data generation model based on the model parameters to be fitted, and then the stylized image in which the two style types are fused is generated based on the target style data generation model. In this way, the target style data generation model can be efficiently constructed without using a large number of training samples in which the two style types are fused, therefore the user can not only generate an image of a target style type by using the model, and meanwhile, the cost consumed in the model construction process is also reduced.

Based on the above solution, after the target style data generation model is obtained, the face image input by the user may be processed to obtain an image having multiple styles at the same time. At this time, since the model is obtained based on weighted averaging of parameters in the first target sample generation model and parameters in the second target sample generation model, there may be the problem of a poor output image effect. In view of this problem, the target style data generation model may be optimized in the following manner.

Exemplarily, the target style data generation model is optimized in the following manner: inputting Gaussian noise into the target style data generation model, so as to obtain a stylized image to be corrected in which the first style type is fused with the second style type; and correcting the stylized image to be corrected to determine a target style image, using the target style image as a target training sample, and then correcting model parameters in the target style data generation model based on the target training sample, so as to obtain the updated target style data generation model.

Taking FIG. 3 as an example, after Gaussian noise z corresponding to the face image of the user is acquired, the Gaussian noise z may be input into the target style data generation model G4, correspondingly, an image output by the G4 is the stylized image to be corrected, it can be understood that although the stylized image to be corrected retains the unique facial features of the user, however the presented effect does not reach relatively high accuracy while reflecting the first style type and the second style type, or, the fusion state of the two style types is relatively stiff. At this time, the stylized image to be corrected may be corrected based on a related application, for example, the saturation, contrast, ambiguity, texture and other parameters of the image are adjusted based on a pre-written script or related drawing software, so as to obtain a target style image better conforming to the expectation of the user. Those skilled in the art should understand that, the target style image obtained by correction may be used as training data to train the target style data generation model in a subsequent process.

In the present embodiment, the manner of correcting the model parameters to update the model may be: inputting Gaussian noise into the target style data generation model, so as to output a stylized image to be corrected; processing the stylized image to be corrected and the target style image based on the discriminator, so as to determine loss values; and correcting model parameters in the target style data generation model based on the loss values, so as to obtain the updated target style data generation model.

In the present embodiment, after the Gaussian noise corresponding to the facial features of the user is acquired, a plurality of pieces of Gaussian noise may be processed by using the target style data generation model, so as to generate stylized image to be corrected to be discriminated, that is, images that do not completely present the target style type. After the stylized image to be corrected and the target style image are determined, a plurality of corresponding loss values may be determined based on the discriminator. When the model parameters in the target style data generation model are corrected by using the plurality of loss values, a training error of the loss function in the model, that is, a loss parameter, may be used as a condition for detecting whether the loss function reaches convergence, for example, whether the training error is less than a preset error or whether an error change trend tends to be stable, or whether the current number of iterations is equal to a preset number of iterations. If it is detected that a convergence condition is met, for example, the training error of the loss function is less than the preset error, or the error change trend tends to be stable, it indicates that the training of the target style data generation model is completed, and at this time, iterative training may be stopped. If it is detected that the convergence condition is not met at present, other Gaussian noise may be further processed to generate a new stylized image to be corrected, so as to continue to train the model, until the training error of the loss function is within a preset range. It can be understood that, when the training error of the loss function reaches convergence, a trained target style data generation model may be obtained, at this time, after the Gaussian noise corresponding to the face image of the user is input into the model, it is possible to obtain a face image of the user, which not only retains the unique facial features of the user, but also can present the first style type and the second style type.

It should also be noted that, in the present technical solution, the target stylized image corresponds to a target special effect image mentioned in the present technical solution.

It should be noted that, in the actual application process, the constructed target style data generation model may be deployed in related application software. It can be understood that, when it is detected that the user triggers a special effect control related to the target style data generation model, a special effect-related program may be run. Exemplarily, if a face image of the user is received based on an import operation of the user (e.g., if the user uploads a photo by means of a related button), or the face image of the user is collected based on a photographing apparatus of a mobile terminal (e.g., if the user performs a real-time video), these images may be converted to display a stylized image in which two style types are fused.

### Embodiment 2

FIG. 4 is a schematic flowchart of a method for generating a stylized image provided in Embodiment 2 of the present disclosure, based on the forgoing embodiment, after the target style data generation model is obtained, a target compilation model obtained by training may also be combined with the target style data generation model, so as obtain a complete special effect image generation model. Exemplarily, the special effect image generation model is deployed in a mobile terminal, so as to provide the user with a service for generating special effect images of a plurality of styles based on the input images. The specific implementation may refer to the technical solution in the present embodiment. Technical terms the same as or corresponding to the above embodiment are not described herein again.

As shown in FIG. 4, the method includes the following steps:
S201, acquiring model parameters to be transferred of a face image generation model, so as to construct a first sample generation model to be trained and a second sample generation model to be trained based on the model parameters to be transferred.
S202, training the first sample generation model to be trained based on training samples of a first style type, so as to obtain a first target sample generation model.
S203, training the second sample generation model to be trained based on training samples of a second style type, so as to obtain a second target sample generation model.
S204, determining a target style data generation model based on model parameters to be fitted of the first target sample generation model and model parameters to be fitted of the second target sample generation model, so as to generate, based on the target style data generation model, a stylized image in which the first style type is fused with the second style type.
S205, determining a special effect image generation model.

In the present embodiment, after the target style data generation model is obtained, in order to provide corresponding services for the user, that is, the user users the model to enable the input face image to present a corresponding special effect, and the corresponding special effect image generation model still needs to be constructed based on the target style data generation model.

Generally, after the special effect image generation model is obtained, the special effect image generation model still needs to be deployed in the terminal device, since the terminal device generally has the function of collecting the face image of the user, the target style data generation model obtained by training may only process Gaussian noise corresponding to the face image of the user. Therefore, in order to effectively run the special effect image generation model on the terminal device, it is also necessary to determine a model capable of generating corresponding Gaussian noise based on the face image of the user, that is, a target compilation model.

Exemplarily, a compilation model to be trained is trained based on the face image generation model and a plurality of face images, so as to obtain a target compilation model; and a special effect image generation model is determined based on the target compilation model and the target style data generation model, and then stylization processing is performed on an acquired face image to be processed based on the special effect image generation model, so as to obtain a target special effect image in which the first style type is fused with the second style type.

The face image is an image, which is input by the user and contains facial features, for example, an ID photo or a life photo of the user, and the like, the compilation model to be trained may be an encoder model, and those skilled in the art should understand that an encoder-decoder framework is a model framework of a deep learning type, and details are not described herein again in the embodiment of the present disclosure. After a plurality of face images are input into the encoder model, and Gaussian noise output by the encoder model is processed based on the face image generation model, it is possible to obtain a corresponding image that may be used as training data of the compilation model to be trained.

Exemplarily, the training process of the compilation model to be trained includes: acquiring a plurality of first training images; for each first image to be trained, inputting the current first training image into the compilation model to be trained, so as to obtain Gaussian noise to be used corresponding to the current first training image; inputting the Gaussian noise to be used into the face image generation model, so as to obtain a third actual output image; determining an image loss value based on the third actual output image and the current first training image; and correcting model parameters in the compilation model to be trained based on the image loss value, converging a loss function in the compilation model to be trained as a training target, so as to obtain the target compilation model, and then determining the special effect image generation model based on the target compilation model and the target style data generation model.

In the present embodiment, after the first training images including the facial features of the user are acquired, the plurality of images may be processed by using the compilation model to be trained, so as to generate the corresponding Gaussian noise to be used, and these pieces of Gaussian noise are actually high-dimensional vectors that cannot accurately and completely reflect the facial features of the user. These pieces of Gaussian noise to be used are processed by using the face image generation model to obtain the third actual output images that are not completely consistent with the first training images. After the third actual output images and the current first training image are determined, a plurality of corresponding loss values may be determined based on the discriminator. When the model parameters in the compilation model to be trained are corrected by using the plurality of loss values, a training error of the loss function in the model, that is, a loss parameter, may be used as a condition for detecting whether the loss function reaches convergence, for example, whether the training error is less than a preset error or whether an error change trend tends to be stable, or whether the current number of iterations is equal to a preset number of iterations. If it is detected that a convergence condition is met, for example, the training error of the loss function is less than the preset error, or the error change trend tends to be stable, it indicates that the training of the compilation model to be trained is completed, and at this time, iterative training may be stopped. If it is detected that the convergence condition is not met at present, other first training images may be further processed, and third actual output images corresponding to the obtained Gaussian vectors are generated based on the face image generation model to continue to train the model, until the training error of the loss function is within a preset range. When the training error of the loss function reaches convergence, a trained target compilation model may be obtained. It can be understood that, the target compilation model is configured to process the input face images into corresponding Gaussian noise, and after the face image of the user is input into the target compilation model, the face image generation model may output, based on the Gaussian noise output by the target compilation model, an image that is almost completely consistent with the face image of the user.

In the present embodiment, after the target compilation model is obtained, the target compilation model is combined with the target style data generation model to obtain the special effect image generation model. Taking FIG. 3 as an example, after the target compilation model (that is, a model corresponding to an identifier E shown in FIG. 3) is obtained, the model may be combined with G4 to obtain the special effect image generation model, after the user inputs the face image into the special effect image generation model, the target compilation model in the model may process the image, Gaussian noise z obtained by processing is input into G4, and after the processing of G4, it is possible to obtain a target special effect image, which not only retains the unique facial features of the user, but also may present a specific regional style and an ancient style at the same time.
S206, deploying the special effect image generation model in a mobile terminal, so that a collected image to be processed is processed into a target special effect image in which the first style type is combined with the second style type when a special effect display control is detected.

In the present embodiment, after the special effect image generation model is obtained, in order to use the model to provide corresponding services for the user, the model may be deployed in the mobile terminal, for example, the special effect image generation model is integrated, based on a specific program algorithm, into an application (APP) developed for a mobile platform.

Exemplarily, a corresponding control may be developed in the APP for the special effect image, for example, a button called a “multi-style special effect” is developed in an application interface of the APP, and meanwhile, the button is associated with a function of generating images of multiple style types based on the special effect image generation model. On this basis, when it is detected that the user triggers the button, it is possible to call images that are input by the user in real time based on the mobile terminal, or call images that are pre-stored in the mobile terminal. It can be understood that, the called images at least include the face image of the user, and these images are image to be processed s.

Exemplarily, the image to be processed s may be processed based on program codes corresponding to the special effect image generation model, so as to obtain a target special effect image, which not only retains the unique facial features of the user, but also fuses the first style type with the second style type at the same time, that is, the special effect image output by G4 in FIG. 3.

In the technical solution of the present embodiment, after the target style data generation model is obtained, the target compilation model obtained by training may also be combined with the target style data generation model to obtain a complete special effect image generation model; and the special effect image generation model is deployed in the mobile terminal, so as to provide the user with a service for generating special effect images of a plurality of styles based on the input images.

### Embodiment 3

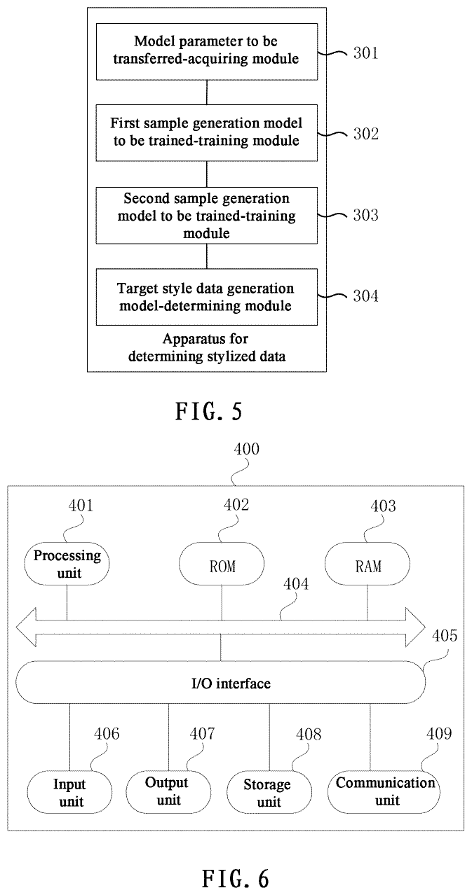

FIG. 5 is a schematic flowchart of an apparatus for generating a stylized image provided in Embodiment 3 of the present disclosure, the apparatus may execute the method for generating the stylized image provided in any embodiment of the present disclosure and has corresponding functional modules for executing the method. As shown in FIG. 5, the apparatus includes: a model parameter to be transferred-acquiring module 301, a first sample generation model to be trained-training module 302, a second sample generation model to be trained-training module 303, and a target style data generation model-determining module 304.

The model parameter to be transferred-acquiring module 301 is configured to acquire model parameters to be transferred of a face image generation model, so as to construct a first sample generation model to be trained and a second sample generation model to be trained based on the model parameters to be transferred.

The first sample generation model to be trained-training module 302 is configured to train the first sample generation model to be trained based on training samples of a first style type, so as to obtain a first target sample generation model.

The second sample generation model to be trained-training module 303 is configured to train the second sample generation model to be trained based on training samples of a second style type, so as to obtain a second target sample generation model.

The target style data generation model-determining module 304 is configured to determine a target style data generation model based on model parameters to be fitted of the first target sample generation model and model parameters to be fitted of the second target sample generation model, so as to generate, based on the target style data generation model, a stylized image in which the first style type is fused with the second style type.

Based on the above technical solutions, the apparatus for generating the stylized image further includes a face image generation model-determining module.

The face image generation model-determining module is configured to acquire a plurality of basic training samples, wherein each basic training sample includes Gaussian noise corresponding to the facial information of a target subject; process the Gaussian noise based on an image to be trained generator, so as to generate an image to be discriminated; perform discrimination processing on the image to be discriminated and a collected real face image based on a discriminator, so as to determine a reference loss value; correct model parameters in the image to be trained generator based on the reference loss value; and converge a loss function in the image to be trained generator as a training target, so as to obtain the face image generation model.

Based on the above technical solutions, the first sample generation model to be trained-training module 302 includes a first style type training sample acquisition unit, a first actual output image determination unit, a first correction unit, and a first target sample generation model determination unit.

The first style type training sample acquisition unit is configured to acquire a plurality of training samples of the first style type, wherein each training sample includes a first face image of the first style type.

The first actual output image determination unit is configured to input Gaussian noise corresponding to the first face images into the first sample generation model to be trained, so as to obtain first actual output images.

The first correction unit is configured to perform discrimination processing on the first actual output images and the corresponding first face images based on the discriminator, so as to determine loss values, and then correct model parameters in the first sample generation model to be trained based on the loss values.

The first target sample generation model determination unit is configured to converge a loss function in the first image to be trained generation model as a training target, so as to obtain the first target sample generation model.

Based on the above technical solutions, the second sample generation model to be trained-training module 303 includes a second style type training sample acquisition unit, a second actual output image determination unit, a second correction unit, and a second target sample generation model determination unit.

The second style type training sample acquisition unit is configured to acquire a plurality of training samples of the second style type, wherein each training sample includes a second face image of the second style type.

The second actual output image determination unit is configured to input Gaussian noise corresponding to the second face images into the second sample generation model to be trained, so as to obtain second actual output images.

The second correction unit is configured to perform discrimination processing on the second actual output images and the corresponding second face images based on the discriminator, so as to determine loss values, and then correct model parameters in the second sample generation model to be trained based on the loss values.

The second target sample generation model determination unit is configured to converge a loss function in the second image to be trained generation model as a training target, so as to obtain the second target sample generation model.

Based on the above technical solutions, the target style data generation model-determining module 304 includes a fitting parameter acquisition unit, a target model parameter determination unit, and a target style data generation model determination unit.

The fitting parameter acquisition unit is configured to acquire a preset fitting parameter.

The target model parameter determination unit is configured to perform fitting processing on model parameters to be fitted in the first target sample generation model and model parameters to be fitted in the second target sample generation model based on the fitting parameter, so as to obtain target model parameters.

The target style data generation model determination unit is configured to determine the target style data generation model based on the target model parameters.

Based on the above technical solutions, the apparatus for generating the stylized image further includes a target style data generation model updating module.

The target style data generation model updating module is configured to input Gaussian noise into the target style data generation model, so as to obtain a stylized image to be corrected in which the first style type is fused with the second style type; and correct the stylized image to be corrected to determine a target style image, use the target style image as a target training sample, and then correct model parameters in the target style data generation model based on the target training sample, so as to obtain the updated target style data generation model.

Based on the above technical solutions, the apparatus for generating the stylized image further includes a model parameter correction module.

The model parameter correction module is configured to input Gaussian noise into the target style data generation model, so as to output a stylized image to be corrected; process the stylized image to be corrected and the target style image based on the discriminator, so as to determine loss values; and correct the model parameters in the target style data generation model based on the loss values, so as to obtain the updated target style data generation model.

Based on the above technical solutions, the apparatus for generating the stylized image further includes a stylization processing module.

The stylization processing module is configured to train a compilation model to be trained based on the face image generation model and a plurality of face images, so as to obtain a target compilation model, wherein the target compilation model is configured to process the input face images into corresponding Gaussian noise; and determine a special effect image generation model based on the target compilation model and the target style data generation model, and then perform stylization processing on an acquired face image to be processed based on the special effect image generation model, so as to obtain a target special effect image in which the first style type is fused with the second style type.

Based on the above technical solutions, the apparatus for generating the stylized image further includes a target compilation model-determining module.

The target compilation model-determining module is configured to acquire a plurality of first training images; for each first image to be trained, input the current first training image into the compilation model to be trained, so as to obtain Gaussian noise to be used corresponding to the current first training image; input the Gaussian noise to be used into the face image generation model, so as to obtain a third actual output image; determine an image loss value based on the third actual output image and the current first training image; and correct model parameters in the compilation model to be trained based on the image loss value, converge a loss function in the compilation model to be trained as a training target, so as to obtain the target compilation model, and then determine the special effect image generation model based on the target compilation model and the target style data generation model.

Based on the above technical solutions, the apparatus for generating the stylized image further includes a model deployment module.

The model deployment module is configured to deploy the special effect image generation model in a mobile terminal, so that a collected image to be processed is processed into a target special effect image in which the first style type is combined with the second style type when a special effect display control is detected.

Based on the above technical solutions, the first style type is a regional style image, and the second style type is an ancient style image.

In the technical solution of the present embodiment, the model parameters to be transferred of the face image generation model are acquired at first, so as to construct the first sample generation model to be trained and the second sample generation model to be trained based on these parameters, the corresponding sample generation models to be trained are trained based on training samples of two style types, after the model training is completed, the model parameters to be fitted of the two target sample generation models are acquired, so as to determine the target style data generation model based on the model parameters to be fitted, and then the stylized image in which the two style types are fused is generated based on the target style data generation model. In this way, the target style data generation model can be efficiently constructed without using a large number of training samples in which the two style types are fused, therefore the user can not only generate an image of a target style type by using the model, and meanwhile, the cost consumed in the model construction process is also reduced.

The apparatus for generating the stylized image provided in the embodiment of the present disclosure may execute the method for generating the stylized image provided in any embodiment of the present disclosure, and has corresponding functional modules for executing the method.

It is worth noting that, various units and modules included in the above apparatus are only divided according to functional logic, but is not limited to the above division, as long as corresponding functions may be implemented; and in addition, specific names of various functional units are merely for ease of distinguishing each other, rather than limiting the protection scope of the embodiments of the present disclosure.

### Embodiment 4

FIG. 6 is a schematic structural diagram of an electronic device provided in Embodiment 4 of the present disclosure. Referring to FIG. 6 below, it illustrates a schematic structural diagram of an electronic device (e.g., a terminal device or a server in FIG. 6) 400 suitable for implementing the embodiment of the present disclosure. The terminal device in the embodiment of the present disclosure may include, but not limited to, mobile terminals such as mobile phones, notebook computers, digital broadcast receivers, personal digital assistants (PDAs), PADs (Portable Android Devices), portable media players (PMPs), vehicle-mounted terminals (e.g., vehicle-mounted navigation terminals), and the like, and fixed terminals such as digital television (TVs), desktop computers, and the like. The electronic device shown in FIG. 6 is merely an example, and should not bring any limitation to the functions and use ranges of the embodiments of the present disclosure.

As shown in FIG. 6, the electronic device 400 may include a processing unit (e.g., a central processing unit, a graphics processing unit, or the like) 401, which may execute various suitable actions and processes in accordance with a program stored in a read-only memory (ROM) 402 or a program loaded from a storage unit 406 into a random access memory (RAM) 403. In the RAM 403, various programs and data needed by the operations of the electronic device 400 are also stored. The processing unit 401, the ROM 402 and the RAM 403 are connected with each other via a bus 404. An input/output (I/O) interface 405 is also connected to the bus 404.

In general, the following apparatuses may be connected to the I/O interface 405: an editing apparatus 406, including, for example, a touch screen, a touch pad, a keyboard, a mouse, a camera, a microphone, an accelerometer, a gyroscope, and the like; an output unit 407, including, for example, a liquid crystal display (LCD), a speaker, a vibrator, and the like; a storage unit 408, including, for example, a magnetic tape, a hard disk, and the like; and a communication unit 409. The communication unit 409 may allow the electronic device 400 to communicate in a wireless or wired manner with other devices to exchange data. Although FIG. 6 illustrates the electronic device 400 having various apparatuses, it should be understood that not all illustrated apparatuses are required to be implemented or provided. More or fewer apparatuses may alternatively be implemented or provided.

In particular, according to the embodiment of the present disclosure, the processes described above with reference to the flowcharts may be implemented as computer software programs. For example, the embodiment of the present disclosure includes a computer program product, which includes a computer program carried on a non-transient computer-readable medium, and the computer program contains program codes for executing the method illustrated in the flowcharts. In such an embodiment, the computer program may be downloaded and installed from a network via the communication unit 409, or installed from the storage unit 406, or installed from the ROM 402. When the computer program is executed by the processing unit 401, the above functions defined in the method of the embodiments of the present disclosure are executed.

The names of messages or information interacted between a plurality of apparatuses in the embodiments of the present disclosure are for illustrative purposes only and are not intended to limit the scope of these messages or information.

The electronic device provided in the embodiment of the present disclosure belongs to the same inventive concept as the method for generating the stylized image provided in the above embodiments, and for technical details that are not described in detail in the present embodiment, reference may be made to the above embodiments.

### Embodiment 5

The embodiment of the present disclosure provides a computer storage medium, on which a computer program is stored, wherein the program implements, when being executed by a processor, the method for generating the stylized image provided in the above embodiments.

It should be noted that, the computer-readable medium described above in the present disclosure may be either a computer-readable signal medium or a computer-readable storage medium, or any combination of the two. The computer-readable storage medium may be, for example, but is not limited to, an electrical, magnetic, optical, electromagnetic, infrared, or semiconductor system, apparatus or device, or a combination of any of the above. More specific examples of the computer-readable storage medium may include, but are not limited to: an electrical connection having one or more wires, a portable computer magnetic disk, a hard disk, a random access memory, a read-only memory, an erasable programmable read-only memory (EPROM or a flash memory), an optical fiber, a compact disc read-only memory (CD-ROM), an optical storage device, a magnetic storage device, or any suitable combination of the above. In the present disclosure, the computer-readable storage medium may be any tangible medium that contains or stores a program, wherein the program may be used by or in combination with an instruction execution system, apparatus or device. In the present disclosure, the computer-readable signal medium may include a data signal that is propagated in a baseband or used as part of a carrier, wherein the data signal carries computer-readable program codes. Such propagated data signal may take many forms, including, but not limited to, electromagnetic signals, optical signals, or any suitable combination thereof. The computer-readable signal medium may also be any computer-readable medium other than the computer-readable storage medium, and the computer-readable signal medium may send, propagate or transport the program for use by or in combination with the instruction execution system, apparatus or device. Program codes contained on the computer-readable medium may be transmitted with any suitable medium, including, but not limited to: an electrical wire, an optical cable, radio frequency (RF), and the like, or any suitable combination thereof.

In some embodiments, a client and a server may perform communication by using any currently known or future-developed network protocol, such as an HTTP (HyperText Transfer Protocol), and may be interconnected with any form or medium of digital data communication (e.g., a communication network). Examples of the communication network include a local area network (LAN), a wide area network (WAN), an international network (e.g., the Internet), and a peer-to-peer network (e.g., an ad hoc peer-to-peer network), as well as any currently known or future-developed network.

The computer-readable medium may be contained in the above electronic device; and it may also be present separately and is not assembled into the electronic device.

The computer-readable medium carries at least one program that, when being executed by the electronic device, causes the electronic device to perform the following operations:
acquiring model parameters to be transferred of a face image generation model, so as to construct a first sample generation model to be trained and a second sample generation model to be trained based on the model parameters to be transferred;
training the first sample generation model to be trained based on training samples of a first style type, so as to obtain a first target sample generation model;
training the second sample generation model to be trained based on training samples of a second style type, so as to obtain a second target sample generation model; and
determining a target style data generation model based on model parameters to be fitted of the first target sample generation model and model parameters to be fitted of the second target sample generation model, so as to generate, based on the target style data generation model, a stylized image in which the first style type is fused with the second style type.

Computer program codes for executing the operations of the present disclosure may be written in one or more programming languages or combinations thereof. The programming languages include object-oriented programming languages, such as Java, Smalltalk, C++, and conventional procedural programming languages, such as the “C” language or similar programming languages. The program codes may be executed entirely on a user computer, executed partly on the user computer, executed as a stand-alone software package, executed partly on the user computer and partly on a remote computer, or executed entirely on the remote computer or a server. In the case involving the remote computer, the remote computer may be connected to the user computer by means of any type of network, including a local area network (LAN) or a wide area network (WAN), or it may be connected to an external computer (e.g., by means of the Internet using an Internet service provider).

The flowcharts and block diagrams in the drawings illustrate the system architectures, functions and operations of possible implementations of systems, methods and computer program products according to various embodiments of the present disclosure. In this regard, each block in the flowcharts or block diagrams may represent a part of a module, a program segment, or a code, which contains one or more executable instructions for implementing specified logical functions. It should also be noted that, in some alternative implementations, the functions annotated in the blocks may occur out of the sequence annotated in the drawings. For example, two blocks shown in succession may, in fact, be executed substantially concurrently, or the blocks may sometimes be executed in a reverse sequence, depending upon the functions involved. It should also be noted that, each block in the block diagrams and/or flowcharts, and combinations of the blocks in the block diagrams and/or flowcharts may be implemented by dedicated hardware-based systems for executing specified functions or operations, or combinations of dedicated hardware and computer instructions.

The units involved in the described embodiments of the present disclosure may be implemented in a software or hardware manner. The names of the units do not constitute limitations of the units themselves in a certain case, for example, a first acquisition unit may also be described as “a unit for acquiring at least two Internet Protocol addresses”.

The functions described herein above may be executed, at least in part, by one or more hardware logic components. For example, without limitation, example types of the hardware logic components that may be used include: a field programmable gate array (FPGA), an application specific integrated circuit (ASIC), application specific standard parts (ASSPs), a system on chip (SOC), a complex programmable logic device (CPLD), and so on.

In the context of the present disclosure, a machine-readable medium may be a tangible medium, which may contain or store a program for use by or in combination with the instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium would include an electrical connection based on one or more wires, a portable computer disk, a hard disk, a random access memory (RAM), a read-only memory (ROM), an erasable programmable read-only memory (EPROM or a flash memory), an optical fiber, a compact disc-read only memory (CD-ROM), an optical storage device, a magnetic storage device, or any suitable combination thereof.

According to at least one embodiment of the present disclosure, Example 1 provides a method for generating a stylized image, including:
acquiring model parameters to be transferred of a face image generation model, so as to construct a first sample generation model to be trained and a second sample generation model to be trained based on the model parameters to be transferred;
training the first sample generation model to be trained based on training samples of a first style type, so as to obtain a first target sample generation model;
training the second sample generation model to be trained based on training samples of a second style type, so as to obtain a second target sample generation model; and
determining a target style data generation model based on model parameters to be fitted of the first target sample generation model and model parameters to be fitted of the second target sample generation model, so as to generate, based on the target style data generation model, a stylized image in which the first style type is fused with the second style type.

According to at least one embodiment of the present disclosure, Example 2 provides a method for generating a stylized image, further including:
optionally, acquiring a plurality of basic training samples, wherein each basic training sample includes Gaussian noise corresponding to the facial information of a target subject;
processing the Gaussian noise based on an image to be trained generator, so as to generate an image to be discriminated;
performing discrimination processing on the image to be discriminated and a collected real face image based on a discriminator, so as to determine a reference loss value;
correcting model parameters in the image to be trained generator based on the reference loss value; and
converging a loss function in the image to be trained generator as a training target, so as to obtain the face image generation model.

According to at least one embodiment of the present disclosure, Example 3 provides a method for generating a stylized image, further including:
optionally, acquiring a plurality of training samples of the first style type, wherein each training sample includes a first face image of the first style type;
inputting Gaussian noise corresponding to the first face images into the first sample generation model to be trained, so as to obtain first actual output images;
performing discrimination processing on the first actual output images and the corresponding first face images based on the discriminator, so as to determine loss values, and then correcting model parameters in the first sample generation model to be trained based on the loss values; and
converging a loss function in the first image to be trained generation model as a training target, so as to obtain the first target sample generation model.

According to at least one embodiment of the present disclosure, Example 4 provides a method for generating a stylized image, further including:
optionally, acquiring a plurality of training samples of the second style type, wherein each training sample includes a second face image of the second style type;
inputting Gaussian noise corresponding to the second face images into the second sample generation model to be trained, so as to obtain second actual output images;
performing discrimination processing on the second actual output images and the corresponding second face images based on the discriminator, so as to determine loss values, and then correcting model parameters in the second sample generation model to be trained based on the loss values; and
converging a loss function in the second image to be trained generation model as a training target, so as to obtain the second target sample generation model.

According to at least one embodiment of the present disclosure, Example 5 provides a method for generating a stylized image, further including:
optionally, acquiring a preset fitting parameter;
performing fitting processing on model parameters to be fitted in the first target sample generation model and model parameters to be fitted in the second target sample generation model based on the fitting parameter, so as to obtain target model parameters; and
determining the target style data generation model based on the target model parameters.

According to at least one embodiment of the present disclosure, Example 6 provides a method for generating a stylized image, further including:
optionally, inputting Gaussian noise into the target style data generation model, so as to obtain a stylized image to be corrected in which the first style type is fused with the second style type; and
correcting the stylized image to be corrected to determine a target style image, using the target style image as a target training sample, and then correcting model parameters in the target style data generation model based on the target training sample, so as to obtain the updated target style data generation model.

According to at least one embodiment of the present disclosure, Example 7 provides a method for generating a stylized image, further including:
optionally, inputting Gaussian noise into the target style data generation model, so as to output a stylized image to be corrected;
processing the stylized image to be corrected and the target style image based on the discriminator, so as to determine loss values; and
correcting the model parameters in the target style data generation model based on the loss values, so as to obtain the updated target style data generation model.

According to at least one embodiment of the present disclosure, Example 8 provides a method for generating a stylized image, further including:
optionally, training a compilation model to be trained based on the face image generation model and a plurality of face images, so as to obtain a target compilation model, wherein the target compilation model is configured to process the input face images into corresponding Gaussian noise; and
determining a special effect image generation model based on the target compilation model and the target style data generation model, and then performing stylization processing on an acquired face image to be processed based on the special effect image generation model, so as to obtain a target special effect image in which the first style type is fused with the second style type.

According to at least one embodiment of the present disclosure, Example 9 provides a method for generating a stylized image, further including:
optionally, acquiring a plurality of first training images;
for each first image to be trained, inputting the current first training image into the compilation model to be trained, so as to obtain Gaussian noise to be used corresponding to the current first training image;
inputting the Gaussian noise to be used into the face image generation model, so as to obtain a third actual output image;
determining an image loss value based on the third actual output image and the current first training image; and
correcting model parameters in the compilation model to be trained based on the image loss value, converging a loss function in the compilation model to be trained as a training target, so as to obtain the target compilation model, and then determining the special effect image generation model based on the target compilation model and the target style data generation model.

According to at least one embodiment of the present disclosure, Example 10 provides a method for generating a stylized image, further including:
optionally, deploying the special effect image generation model in a mobile terminal, so that a collected image to be processed is processed into a target special effect image in which the first style type is combined with the second style type when a special effect display control is detected.

According to at least one embodiment of the present disclosure, Example 11 provides a method for generating a stylized image, further including:
optionally, the first style type is a regional style image, and the second style type is an ancient style image.

According to at least one embodiment of the present disclosure, Example 12 provides an apparatus for generating a stylized image, including:
a model parameter to be transferred-acquiring module, configured to acquire model parameters to be transferred of a face image generation model, so as to construct a first sample generation model to be trained and a second sample generation model to be trained based on the model parameters to be transferred;
a first sample generation model to be trained-training module, configured to train the first sample generation model to be trained based on training samples of a first style type, so as to obtain a first target sample generation model;
a second sample generation model to be trained-training module, configured to train the second sample generation model to be trained based on training samples of a second style type, so as to obtain a second target sample generation model; and
a target style data generation model-determining module, configured to determine a target style data generation model based on model parameters to be fitted of the first target sample generation model and model parameters to be fitted of the second target sample generation model, so as to generate, based on the target style data generation model, a stylized image in which the first style type is fused with the second style type.

In addition, although various operations are described in a particular sequence, this should not be understood as requiring that these operations are executed in the particular sequence shown or in a sequential order. In certain circumstances, multitasking and parallel processing may be advantageous. Similarly, although several specific implementation details have been contained in the above discussion, these should not be construed as limiting the scope of the present disclosure. Certain features that are described in the context of separate embodiments may also be implemented in combination in a single embodiment. Conversely, various features that are described in the context of a single embodiment may also be implemented in a plurality of embodiments separately or in any suitable sub-combination.

What is claimed is:

1. A method for generating a stylized image, comprising:
acquiring model parameters to be transferred of a face image generation model to construct a first sample generation model to be trained and a second sample generation model to be trained based on the model parameters to be transferred;
training the first sample generation model to be trained based on training samples of a first style type to obtain a first target sample generation model;
training the second sample generation model to be trained based on training samples of a second style type to obtain a second target sample generation model; and
determining a target style data generation model based on model parameters to be fitted of the first target sample generation model and model parameters to be fitted of the second target sample generation model to generate, based on the target style data generation model, a stylized image in which the first style type is fused with the second style type.

2. The method according to claim 1, wherein a face image to be trained generation model comprises an image to be trained generator and a discriminator, and before acquiring the model parameters to be transferred of the face image generation model, the method further comprises:
acquiring a plurality of basic training samples, wherein each basic training sample comprises Gaussian noise corresponding to the facial information of a target subject;
processing the Gaussian noise based on the image to be trained generator to generate an image to be discriminated;
performing discrimination processing on the image to be discriminated and a collected real face image based on the discriminator to determine a reference loss value;
correcting model parameters in the image to be trained generator based on the reference loss value; and
converging a loss function in the image to be trained generator as a training target to obtain the face image generation model.

3. The method according to claim 1, wherein training the first sample generation model to be trained based on the training samples of the first style type to obtain the first target sample generation model, comprises:
acquiring a plurality of training samples of the first style type, wherein each training sample comprises a first face image of the first style type;
inputting Gaussian noise corresponding to the first face images into the first sample generation model to be trained to obtain first actual output images;
performing discrimination processing on the first actual output images and the corresponding first face images based on the discriminator to determine loss values, and then correcting model parameters in the first sample generation model to be trained based on the loss values; and
converging a loss function in the first image to be trained generation model as a training target to obtain the first target sample generation model.

4. The method according to claim 1, wherein training the second sample generation model to be trained based on the training samples of the second style type to obtain the second target sample generation model, comprises:
acquiring a plurality of training samples of the second style type, wherein each training sample comprises a second face image of the second style type;
inputting Gaussian noise corresponding to the second face images into the second sample generation model to be trained to obtain second actual output images;
performing discrimination processing on the second actual output images and the corresponding second face images based on the discriminator to determine loss values, and then correcting model parameters in the second sample generation model to be trained based on the loss values; and
converging a loss function in the second image to be trained generation model as a training target to obtain the second target sample generation model.

5. The method according to claim 1, wherein determining the target style data generation model based on the model parameters to be fitted of the first target sample generation model and model parameters to be fitted of the second target sample generation model, comprises:
acquiring a preset fitting parameter;
performing fitting processing on model parameters to be fitted in the first target sample generation model and model parameters to be fitted in the second target sample generation model based on the fitting parameter to obtain target model parameters; and
determining the target style data generation model based on the target model parameters.

6. The method according to claim 1, wherein after the target style data generation model is obtained, the method further comprises:
inputting Gaussian noise into the target style data generation model to obtain a stylized image to be corrected in which the first style type is fused with the second style type; and
correcting the stylized image to be corrected to determine a target style image, using the target style image as a target training sample, and then correcting model parameters in the target style data generation model based on the target training sample to obtain the updated target style data generation model.

7. The method according to claim 6, wherein correcting the model parameters in the target style data generation model based on the target training sample to obtain the updated target style data generation model, comprises:
inputting Gaussian noise into the target style data generation model to output a stylized image to be corrected;
processing the stylized image to be corrected and the target style image based on the discriminator to determine loss values; and
correcting the model parameters in the target style data generation model based on the loss values to obtain the updated target style data generation model.

8. The method according to claim 2, further comprising:
training a compilation model to be trained based on the face image generation model and a plurality of face images to obtain a target compilation model, wherein the target compilation model is configured to process the input face images into corresponding Gaussian noise; and
determining a special effect image generation model based on the target compilation model and the target style data generation model, and then performing stylization processing on an acquired face image to be processed based on the special effect image generation model to obtain a target special effect image in which the first style type is fused with the second style type.

9. The method according to claim 8, wherein training the compilation model to be trained based on the face image generation model and the plurality of face images to obtain the target compilation model, comprises:
acquiring a plurality of first training images;
for each first image to be trained, inputting the current first training image into the compilation model to be trained to obtain Gaussian noise to be used corresponding to the current first training image;
inputting the Gaussian noise to be used into the face image generation model to obtain a third actual output image;
determining an image loss value based on the third actual output image and the current first training image; and
correcting model parameters in the compilation model to be trained based on the image loss value, converging a loss function in the compilation model to be trained as a training target to obtain the target compilation model, and then determining the special effect image generation model based on the target compilation model and the target style data generation model.

10. The method according to claim 8, further comprising:
deploying the special effect image generation model in a mobile terminal, and in response to detecting a special effect display control, processing a collected image to be processed into a target special effect image in which the first style type is combined with the second style type.

11. The method according to claim 1, wherein the first style type is a regional style image, and the second style type is an ancient style image.

12-22. (canceled)

23. An electronic device, comprising:
at least one processor; and
a storage unit, configured to store at least one instruction that, when executed by the at least one processor, cause the electronic device to:
acquire model parameters to be transferred of a face image generation model to construct a first sample generation model to be trained and a second sample generation model to be trained based on the model parameters to be transferred;
train the first sample generation model to be trained based on training samples of a first style type to obtain a first target sample generation model;
train the second sample generation model to be trained based on training samples of a second style type to obtain a second target sample generation model; and
determine a target style data generation model based on model parameters to be fitted of the first target sample generation model and model parameters to be fitted of the second target sample generation model to generate, based on the target style data generation model, a stylized image in which the first style type is fused with the second style type.

24. A non-transitory computer-readable storage medium, comprising a computer-executable instruction, wherein the computer-executable instruction is used for, when being executed by a computer processor, implementing acts comprising:
acquiring model parameters to be transferred of a face image generation model to construct a first sample generation model to be trained and a second sample generation model to be trained based on the model parameters to be transferred;
training the first sample generation model to be trained based on training samples of a first style type to obtain a first target sample generation model;
training the second sample generation model to be trained based on training samples of a second style type to obtain a second target sample generation model; and
determining a target style data generation model based on model parameters to be fitted of the first target sample generation model and model parameters to be fitted of the second target sample generation model to generate, based on the target style data generation model, a stylized image in which the first style type is fused with the second style type.

25. The electronic device according to claim 23, wherein a face image to be trained generation model comprises an image to be trained generator and a discriminator, and before acquiring the model parameters to be transferred of the face image generation model, the electronic device is further caused to:
acquire a plurality of basic training samples, wherein each basic training sample comprises Gaussian noise corresponding to the facial information of a target subject;
process the Gaussian noise based on the image to be trained generator to generate an image to be discriminated;
perform discrimination processing on the image to be discriminated and a collected real face image based on the discriminator to determine a reference loss value;
correct model parameters in the image to be trained generator based on the reference loss value; and
converge a loss function in the image to be trained generator as a training target to obtain the face image generation model.

26. The electronic device according to claim 23, wherein training the first sample generation model to be trained based on the training samples of the first style type to obtain the first target sample generation model, comprises:
acquiring a plurality of training samples of the first style type, wherein each training sample comprises a first face image of the first style type;
inputting Gaussian noise corresponding to the first face images into the first sample generation model to be trained to obtain first actual output images;
performing discrimination processing on the first actual output images and the corresponding first face images based on the discriminator to determine loss values, and then correcting model parameters in the first sample generation model to be trained based on the loss values; and
converging a loss function in the first image to be trained generation model as a training target to obtain the first target sample generation model.

27. The electronic device according to claim 23, wherein training the second sample generation model to be trained based on the training samples of the second style type to obtain the second target sample generation model, comprises:
acquiring a plurality of training samples of the second style type, wherein each training sample comprises a second face image of the second style type;
inputting Gaussian noise corresponding to the second face images into the second sample generation model to be trained to obtain second actual output images;
performing discrimination processing on the second actual output images and the corresponding second face images based on the discriminator to determine loss values, and then correcting model parameters in the second sample generation model to be trained based on the loss values; and
converging a loss function in the second image to be trained generation model as a training target to obtain the second target sample generation model.

28. The electronic device according to claim 23, wherein determining the target style data generation model based on the model parameters to be fitted of the first target sample generation model and model parameters to be fitted of the second target sample generation model, comprises:
acquiring a preset fitting parameter;
performing fitting processing on model parameters to be fitted in the first target sample generation model and model parameters to be fitted in the second target sample generation model based on the fitting parameter to obtain target model parameters; and
determining the target style data generation model based on the target model parameters.

29. The non-transitory computer-readable storage medium according to claim 24, wherein training the first sample generation model to be trained based on the training samples of the first style type to obtain the first target sample generation model, comprises:
acquiring a plurality of training samples of the first style type, wherein each training sample comprises a first face image of the first style type;
inputting Gaussian noise corresponding to the first face images into the first sample generation model to be trained to obtain first actual output images;
performing discrimination processing on the first actual output images and the corresponding first face images based on the discriminator to determine loss values, and then correcting model parameters in the first sample generation model to be trained based on the loss values; and
converging a loss function in the first image to be trained generation model as a training target to obtain the first target sample generation model.

30. The non-transitory computer-readable storage medium according to claim 24, wherein training the second sample generation model to be trained based on the training samples of the second style type to obtain the second target sample generation model, comprises:
acquiring a plurality of training samples of the second style type, wherein each training sample comprises a second face image of the second style type;
inputting Gaussian noise corresponding to the second face images into the second sample generation model to be trained to obtain second actual output images;
performing discrimination processing on the second actual output images and the corresponding second face images based on the discriminator to determine loss values, and then correcting model parameters in the second sample generation model to be trained based on the loss values; and
converging a loss function in the second image to be trained generation model as a training target to obtain the second target sample generation model.

31. The non-transitory computer-readable storage medium according to claim 24, wherein determining the target style data generation model based on the model parameters to be fitted of the first target sample generation model and model parameters to be fitted of the second target sample generation model, comprises:
acquiring a preset fitting parameter;
performing fitting processing on model parameters to be fitted in the first target sample generation model and model parameters to be fitted in the second target sample generation model based on the fitting parameter to obtain target model parameters; and
determining the target style data generation model based on the target model parameters.
